(19) United States
(12) Patent Application Publication
(10) Pub. No.: US 2025/0368543 A1
(43) Pub. Date: Dec. 4, 2025

(54) MODULAR TREATMENT FILTER SYSTEM VALVE MODULE

(71) Applicants: JASON DOWNEY, MANOTICK (CA); ARDJAN MUCA, MANOTICK (CA)

(72) Inventors: JASON DOWNEY, MANOTICK (CA); ARDJAN MUCA, MANOTICK (CA)

(21) Appl. No.: 19/226,939

(22) Filed: Jun. 3, 2025

Related U.S. Application Data
(60) Provisional application No. 63/655,780, filed on Jun. 4, 2024.

(51) Int. Cl. C02F 1/00

(52) U.S. Cl. CPC C02F 1/001; C02F 2201/005; C02F 2201/007; C02F 2201/008

(57) ABSTRACT

Typically, filtration systems are custom designed with multiple treatment stages to address the requirements of the project and site with a capacity associated with a design target of the project and site. Such systems have limitations including long delivery cycles, high cost of manufacture and time consuming integration and/or automation. Alternately, a temporary filtration system may be required on a short timescale which may be assembled using subcomponents available through rental supply companies etc. for speed. These temporary filter systems have limitations including high operating labor costs, little to no automation, no cold weather capability and limited treatment stages. Accordingly, it would be desirable to provide an alternate solution wherein a modular configuration exploiting premanufactured and automated filtration system elements is employed where these can be rapidly deployed within insulated containers that support standard shipping/loading/unloading etc.

### CROSS-REFERENCE TO RELATED APPLICATIONS

This patent application claims the benefit of priority to U.S. Patent Application 63/655,780 filed Jun. 4, 2024; the entire contents of which are incorporated herein by reference.

### FIELD OF THE INVENTION

This patent application relates to modular treatment filter systems and more specifically to automated valving modules for modular fluid treatment filtration systems.

### BACKGROUND OF THE INVENTION

Filtration systems employ filters to remove unwanted substances from a fluid flowing through or pumped through the filtration system. These filters may use sieving, adsorption, ion exchange, biofilms or other processes. A common fluid being water where the filtration system may be employed for treating contaminated surface water, industrial wastewater or groundwater for example where each filtration project and filtration site is faced with a different set of contaminants, effluent objectives, flow rates etc.

Commonly, these filtration systems are custom designed with multiple treatment stages to address the requirements of the project and site. Further, these filtration systems are typically designed for a capacity associated with a design target of the project and site. Such custom filtration systems have limitations including, but not limited to, long delivery cycles, high cost of manufacture, expensive and time consuming integration and/or automation as a large treatment process. Furthermore, these systems are expensive to ship and handle requiring dedicated flatbed trucks and cranes for loading and offloading etc.

Within other applications a temporary filtration system may be required on a short timescale where to meet these timescales simplified filtration systems may be assembled at the sites using subcomponents available through rental supply companies etc. These temporary filter system solutions have limitations including, but not limited to, high operating labor costs, little to no automation, not suitable for cold weather operation and limited treatment stages.

Accordingly, it would be desirable to provide an alternate solution wherein a modular configuration exploiting premanufactured and automated filtration system elements is employed. With a modular configuration shipping and handling costs can be reduced, filtration system elements can be sourced from multiple manufacturing locations for speed and modular elements may be self-contained insulated enclosures suitable for cold weather operation. Further, through distributed automation within each modular filtration system element assembly complexity at the site can be reduced to mechanical couplings and electrical connections.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to automated valving modules for modular fluid treatment filtration systems.

In accordance with an embodiment of the invention there is provided a device comprising:
an inlet comprising at least a pair of inlet ports for receiving a fluid from a first part of a fluidic system;
an outlet comprising at least a pair of outlet ports for providing a processed portion of the fluid to a second part of the fluidic system;
an exhaust comprising at least a pair of exhaust ports for providing another processed portion of the fluid to another fluidic system;
a filter port of a pair of filter ports for receiving the fluid from the inlet and coupling it to one or more modules of a first set of processing modules;
another filter port of the pair of filter ports for receiving the fluid from the inlet and coupling it to one or more modules of a second set of processing modules;
a port for receiving the processed portion of the fluid from the first set of processing modules;
another port for receiving the processed portion of the fluid from the second set of processing modules; and
a valve array comprising:
   a first upper valve coupled between the inlet and a filter port of the pair of filter ports;
   a first lower valve coupled between the filter port of the pair of filter ports and the exhaust;
   a second upper valve coupled between the inlet and another filter port of the pair of filter ports;
   a first lower valve coupled between the another filter port of the pair of filter ports and the exhaust; and
   a central valve coupled between the pair of ports and the outlet; wherein
the first upper valve, the first lower valve, the second upper valve, the second lower valve and central valve are controllable to different states between an open state and a closed state under action of a controller to establish the device into a configuration of a series of configurations; and
the series of configurations comprises:
   a first configuration wherein fluid from the first part of the fluidic system is coupled to the outlet after being processed by the one or more modules of the first set of processing modules;
   a second configuration wherein fluid from the first part of the fluidic system is coupled to the outlet after being processed by the one or more modules of the second set of processing modules;
   a third configuration wherein a portion of the fluid from the first part of the fluidic system is coupled to the outlet after being processed by the one or more modules of the first set of processing modules and another portion of the fluid from the first part of the fluidic system is coupled to the outlet after being processed by the one or more modules of the second set of processing modules;
   a fourth configuration wherein a portion of the fluid from the first part of the fluidic system is coupled to the exhaust after being processed by the one or more modules of the first set of processing modules and employed to one of backwash and rinse one or more modules of the second set of processing modules; and
   a fifth configuration wherein a portion of the fluid from the first part of the fluidic system is coupled to the exhaust after being processed by the one or more modules of the second set of processing modules and employed to one of backwash and rinse one or more modules of the first set of processing modules.

In accordance with an embodiment of the invention there is provided a device comprising:
a filter port of a pair of filter ports for receiving the fluid from an inlet and coupling it to one or more modules of a first set of processing modules;
another filter port of the pair of filter ports for receiving the fluid from the inlet and coupling it to one or more modules of a second set of processing modules;
a port for receiving the processed portion of the fluid from the first set of processing modules;
another port for receiving the processed portion of the fluid from the second set of processing modules; and
a valve array comprising:
   a first upper valve coupled between the inlet and a filter port of the pair of filter ports;
   a first lower valve coupled between the filter port of the pair of filter ports and the exhaust;
   a second upper valve coupled between the inlet and another filter port of the pair of filter ports;
   a first lower valve coupled between the another filter port of the pair of filter ports and the exhaust; and
   a central valve coupled between the pair of ports and the outlet; wherein
the first upper valve, the first lower valve, the second upper valve, the second lower valve and central valve are controllable to different states between an open state and a closed state under action of a controller to establish the device into a configuration of a series of configurations; and
the series of configurations comprises:
   a first configuration wherein fluid from the first part of the fluidic system is coupled to the outlet after being processed by the one or more modules of the first set of processing modules;
   a second configuration wherein fluid from the first part of the fluidic system is coupled to the outlet after being processed by the one or more modules of the second set of processing modules;
   a third configuration wherein a portion of the fluid from the first part of the fluidic system is coupled to the outlet after being processed by the one or more modules of the first set of processing modules and another portion of the fluid from the first part of the fluidic system is coupled to the outlet after being processed by the one or more modules of the second set of processing modules;
   a fourth configuration wherein a portion of the fluid from the first part of the fluidic system is coupled to the exhaust after being processed by the one or more modules of the first set of processing modules and employed to backwash one or more modules of the second set of processing modules; and
   a fifth configuration wherein a portion of the fluid from the first part of the fluidic system is coupled to the exhaust after being processed by the one or more modules of the second set of processing modules and employed to backwash one or more modules of the first set of processing modules.

In accordance with an embodiment of the invention there is provided a field deployable fluid processing system comprising:
a container;
a valve module; and
a number N fluid processing modules (FPMs) coupled to the valve module; wherein
an inlet comprising a pair of inlet ports for receiving a fluid from a first part of a fluidic system where the pair of inlet ports are disposed through one or more walls of the container;
an outlet comprising a pair of outlet ports for providing a processed portion of the fluid to a second part of the fluidic system where the pair of outlet ports are disposed through one or more walls of the container; and
an exhaust comprising a pair of exhaust ports for providing another processed portion of the fluid to another fluidic system where the pair of exhaust ports are disposed through one or more walls of the container.

In accordance with an embodiment of the invention there is provided a field deployable fluid processing system comprising:
a first container comprising a number N fluid processing modules (FPMs) coupled to a valve module;
a second container comprising a number M fluid processing modules (FPMs) coupled to the valve module;
the valve module comprising:
   an inlet comprising a pair of inlet ports for receiving a fluid from a first part of a fluidic system;
   an outlet comprising a pair of outlet ports for providing a processed portion of the fluid to a second part of the fluidic system;
   an exhaust comprising a pair of exhaust ports for providing another processed portion of the fluid to another fluidic system;
   a filter port of a pair of filter ports for receiving the fluid from the inlet and coupling it to an inlet port of the first container;
   another filter port of the pair of filter ports for receiving the fluid from the inlet and coupling it to an inlet port of the second container;
   a port for receiving the processed portion of the fluid from an outlet port of the first container;
   another port for receiving the processed portion of the fluid from an outlet port of the second container; and
   a valve array comprising:
      a first upper valve coupled between the inlet and a filter port of the pair of filter ports;
      a first lower valve coupled between the filter port of the pair of filter ports and the exhaust;
      a second upper valve coupled between the inlet and another filter port of the pair of filter ports;
      a first lower valve coupled between the another filter port of the pair of filter ports and the exhaust; and
      a central valve coupled between the pair of ports and the outlet; wherein
the first upper valve, the first lower valve, the second upper valve, the second lower valve and central valve are controllable between an open state and a closed state under action of a controller to establish the device into a configuration of a series of configurations; and
M and N are positive integers.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A depicts a seven-valve valving module (7-Valve module) in accordance with the prior art;

FIG. 1B depicts a filter module for connecting to the 7-Valve module of FIG. 1A or the 5-Valve Module of FIG. 4D;

FIGS. 2A to 2C depict a subset of operating modes of a 7-Valve module according to the prior art;

FIG. 3 depicts a five-valve valving module (5-Valve module) in accordance with an embodiment of the invention;

FIG. 4A depicts the 5-Valve module in accordance with an embodiment of the invention in a first configuration with a pair of filter modules;

FIG. 4B depicts the 5-Valve module in accordance with an embodiment of the invention in a second configuration with six filter modules;

FIG. 4C depicts the 5-Valve module in accordance with an embodiment of the invention in a second configuration with ten filter modules;

FIG. 4D depicts a three-dimensional (3D) perspective view of a 5-Valve Module according to the embodiment of the invention within FIGS. 4A to 4C within a housing;

FIG. 4E depicts a three-dimensional (3D) perspective view of a 5-Valve Module according to the embodiment of the invention with an automatic control panel;

FIG. 5 depicts an exemplary deployment scenario of a 5-Valve Module according to an embodiment of the invention for processing mine tailings;

FIG. 6A to 6F depict configurations of valving modules according to embodiments of the invention with filter vessels;

FIG. 7 depicts a 5-Valve module in accordance with an embodiment of the invention in a configuration with six filter modules such as FIG. 6C;

FIGS. 8 and 9 depicts the configuration of FIG. 7 under the operational modes of filtering and backwashing one of the filter vessels to show flow directions;

FIG. 10 depicts an exemplary mobile deployment of a 5-Valve module with 4 filter vessels according to an embodiment of the invention integrated within a standard 40 foot container;

FIG. 11 depicts schematically the configuration of FIG. 10;

FIGS. 12A and 12B depict the configuration of FIG. 11 under the operational modes of filtering and backwashing to show flow directions;

FIG. 13 depicts an exemplary mobile deployment of a 5-Valve module with 6 filter vessels according to an embodiment of the invention integrated within a standard 53 foot container;

FIG. 14 depicts schematically the configuration of FIG. 13; and

FIG. 15 depicts an exemplary mobile deployment of a 5-Valve module with dual 4 filter vessel arrays according to an embodiment of the invention where each 4 filter vessel array is integrated within a standard 40 foot container.

### DETAILED DESCRIPTION

The present invention is directed to automated valving modules for modular fluid treatment filtration systems.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “fluid” as used herein refers to a liquid, a gas, a mixture of liquids or a mixture of gases.

A “wireless standard” as used herein and throughout this disclosure, refer to, but is not limited to, a standard for transmitting signals and/or data through electromagnetic radiation which may be optical, radio-frequency (RF) or microwave although typically RF wireless systems and techniques dominate. A wireless standard may be defined globally, nationally, or specific to an equipment manufacturer or set of equipment manufacturers. Dominant wireless standards at present include, but are not limited to IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, Bluetooth, Wi-Fi, Ultra-Wideband and WiMAX. Some standards may be a conglomeration of sub-standards such as IEEE 802.11 which may refer to, but is not limited to, IEEE 802.1a, IEEE 802.11b, IEEE 802.11g, or IEEE 802.11n as well as others under the IEEE 802.11 umbrella.

A “wired standard” as used herein and throughout this disclosure, generally refer to, but is not limited to, a standard for transmitting signals and/or data through an electrical cable discretely or in combination with another signal. Such wired standards may include, but are not limited to, digital subscriber loop (DSL), Dial-Up (exploiting the public switched telephone network (PSTN) to establish a connection to an Internet service provider (ISP)), Data Over Cable Service Interface Specification (DOCSIS), Ethernet, Gigabit home networking (G.hn), Integrated Services Digital Network (ISDN), Multimedia over Coax Alliance (MoCA), and Power Line Communication (PLC, wherein data is overlaid to AC/DC power supply). In some embodiments a “wired standard” may refer to, but is not limited to, exploiting an optical cable and optical interfaces such as within Passive Optical Networks (PONs) for example.

Whilst the following description describes a modular filtration system comprising a pumping module with a series of filtration modules it would be evident to one of skill in the art that a filtration module may be replaced with another module such as a chemical dosing module, sedimentation module, algae scrubber module, desalination module and an ultraviolet treatment module for example such that fluidic systems addressing a variety of requirements can be rapidly configured with a 5-Valve Module according to embodiments of the invention.

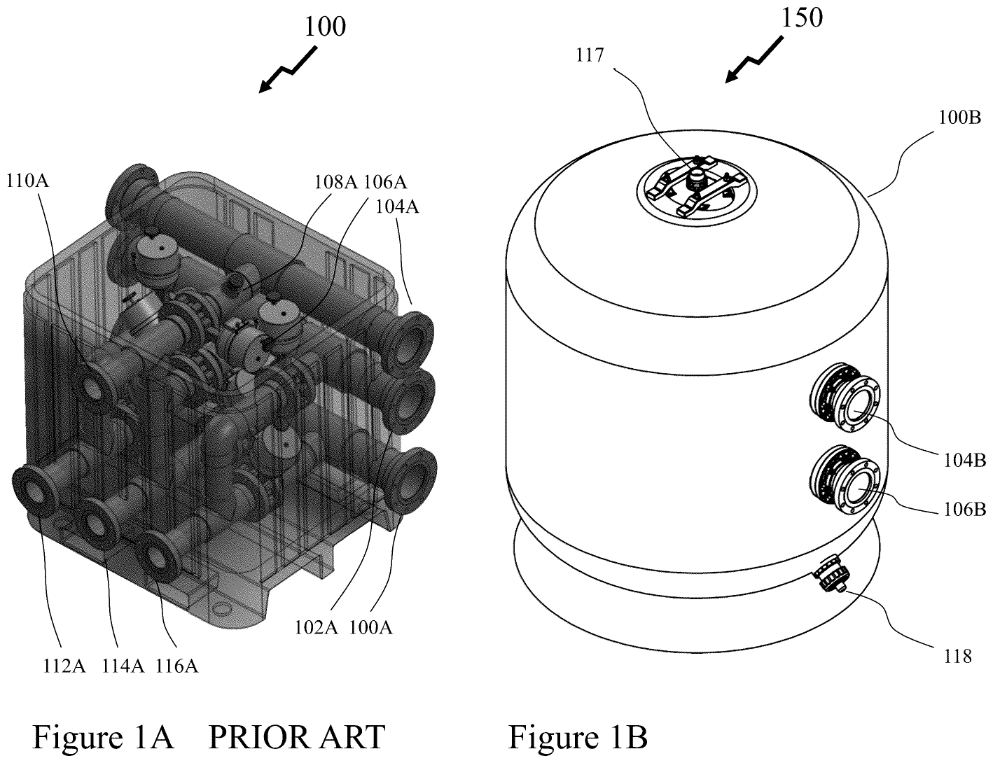

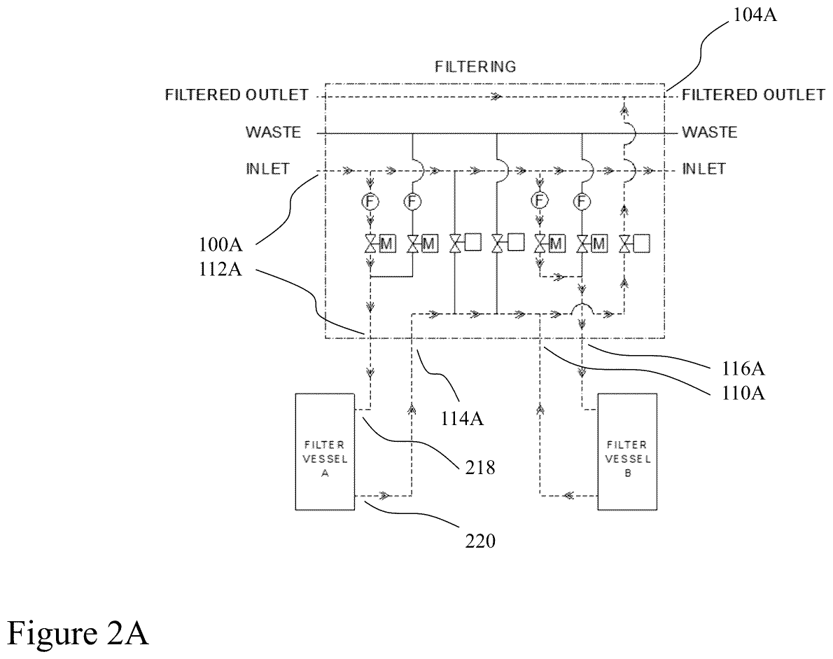

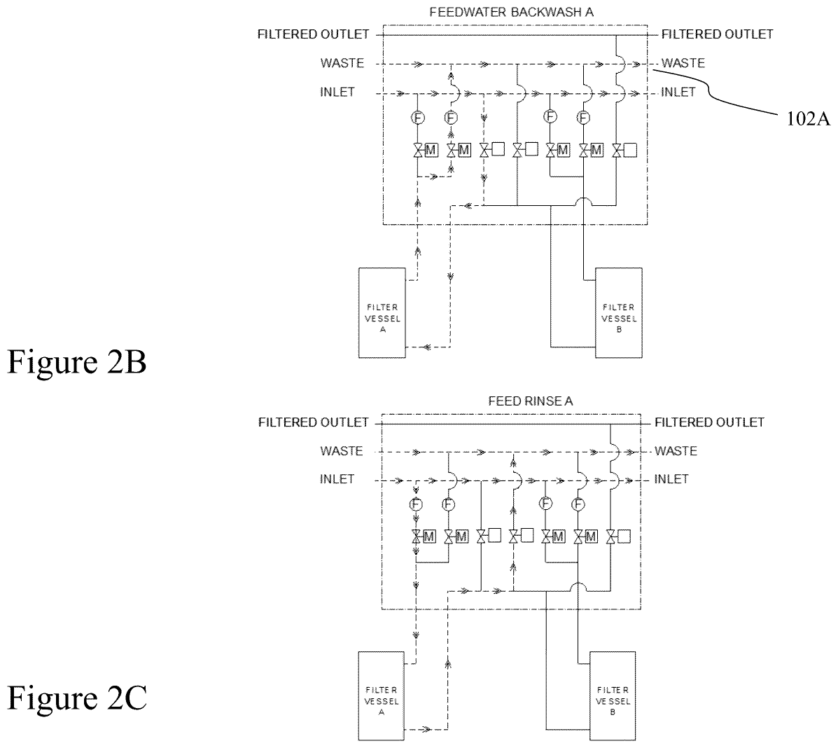

FIG. 1A depicts an isometric view of a seven-valve valving module (7-Valve module) 100 in accordance with the prior art such as depicted within PCT/CA2023/050569 entitled “Portable Insulated Water Treatment Modules and Systems for Purifying Water” the entire contents of which are incorporated herein by reference. 7-Valve Module 100 may comprise a control panel and/or a lid, e.g., plastic lid, to cover the module housing but these have been omitted in FIG. 1 for clarity. The 7-Valve Module 100 is used in conjunction with filter vessels, such as Filter Module 150 in FIG. 1B, for processing a fluid, e.g. water, where the filter vessels may be depth media filter vessels such as sand filters, multimedia filters, micro sand filters, carbon filters, ion exchange filters, and specialty adsorption media filters etc, wherein the filtered fluid is then fed for downstream processing. As depicted in FIGS. 2A to 2C the 7-Valve Module 100 provides for filtering of fluid from upstream to downstream, backwashing of a filter vessel and rinsing if a filter vessel.

As depicted in FIG. 1A a process inlet port 100A is installed at the bottom of the module on both sides, a waste outlet port 102A is installed above the process inlet port 100A, and filtered outlet port 104A is installed above the waste outlet port. Automated valves 106A and flowmeters 108A are installed inside the module housing to enable automated flow control. Depending on the application and/or mode of the 7-Valve Module 100, the automated valves 106A can be modulated and controlled through a controller forming part of the control panel to maintain a desired flow rate for filtering, backwashing, or rinsing. The flowmeters monitor the flow rate within the pipes and control the modular valves to achieve a consistent flow rate. Similarly, depending on the application and/or mode of the 7-Valve Module 100, the automated valves 106A configure the 7-Valve Module 100 for filtering, backwashing and/or filtering.

The 7-Valve Module 100 inlet and outlet ports 100A and 104A are installed on the adjacent wall of the module such that 7-Valve Module 100 can connect to two filter vessels as depicted in FIGS. 2A to 2C. In this embodiment of the 7-Valve Module 100 left port 112A is coupled to the inlet of first Filter Vessel A (depicted schematically as installed on the bottom left of the 7-Valve Module 100 in FIGS. 2A to 2C respectively) and the middle port 114A in connected to the outlet of the first Filter Vessel A. The second Filter Vessel B (depicted schematically as installed on the bottom right of the 7-Valve Module 100 in FIGS. 2A to 2C respectively) is installed by connecting its input to the right port 116A and its output to top port 110A.

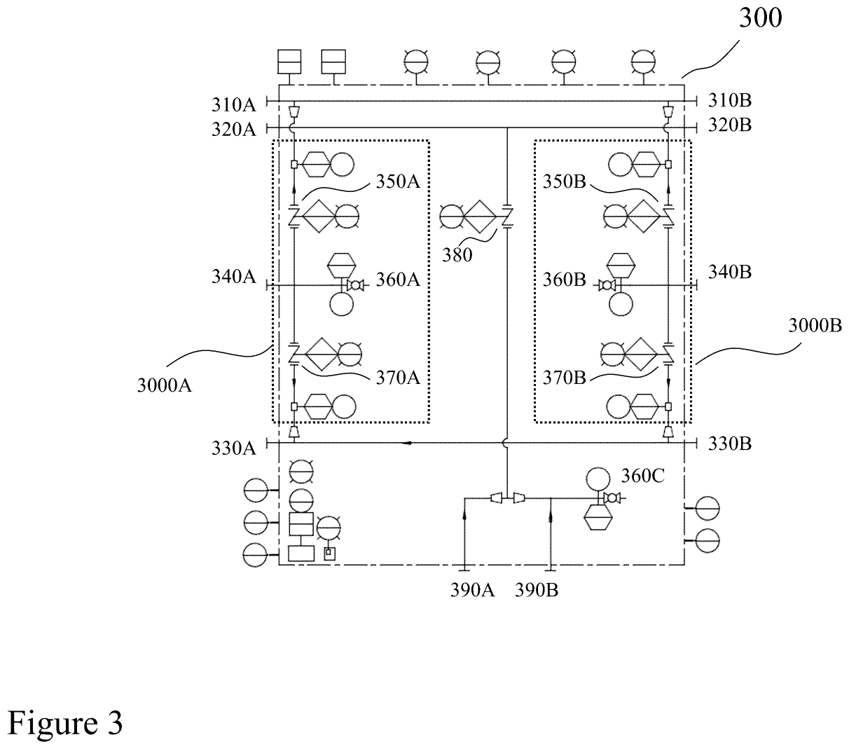

Now referring to FIG. 1B there is depicted an isometric view of a Filter Module 150 as may be employed with respect to five-valve (5-Valve) Modules according to embodiments of the invention as described below in respect of FIGS. 3 to 15. The Filter Module 150 has a housing 100B with a pair of Ports 104B and 106B for fluid inlet and outlet which are connected to a 5-Valve Module as described within this specification and as depicted in the Figures. The Filter Module 150 further comprising a Vent 117 and a Drain 118.

Now referring to FIGS. 2A to 2C there are depicted a subset of operating modes of a 7-Valve module according to the prior art wherein filtering, feedwater backwash and feed rinse modes with respect to first Filter Vessel A are depicted. Other filtering, feedwater backwash and feed rinse modes with respect to second Filter Vessel B are not depicted but would be evident based upon PCT/CA2023/050569 entitled “Portable Insulated Water Treatment Modules and Systems for Purifying Water.” Within FIGS. 2A to 2C different flow configurations of the 7-Valve Module 100 are depicted with the fluid flow directions denoted in arrows and the pipes used denoted in dotted lines.

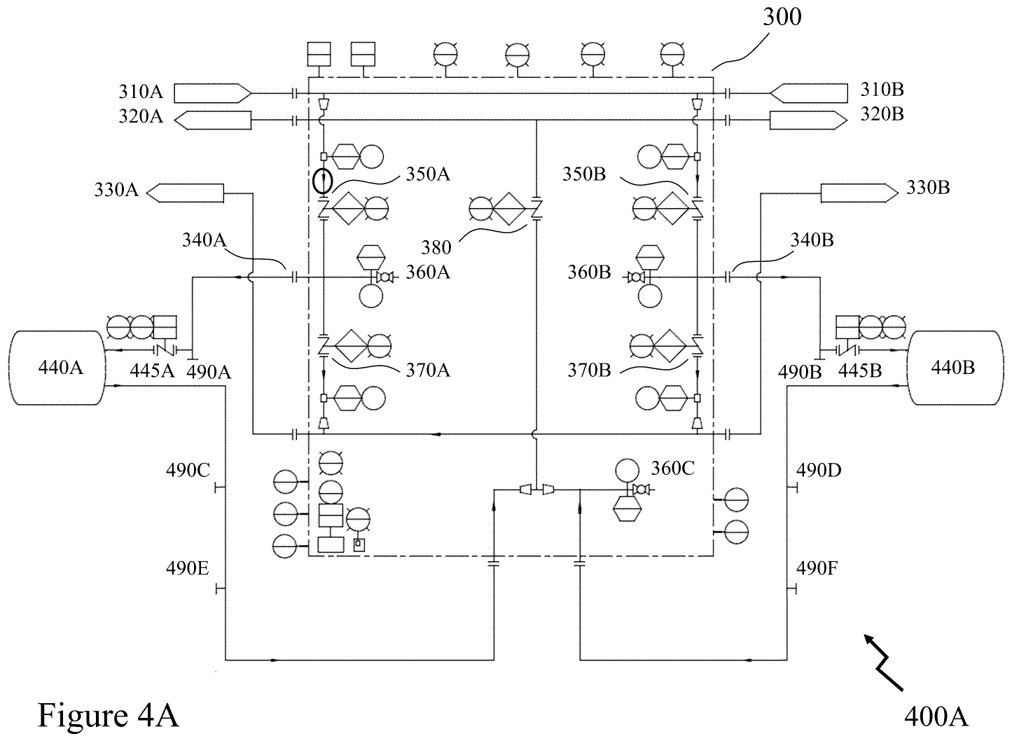

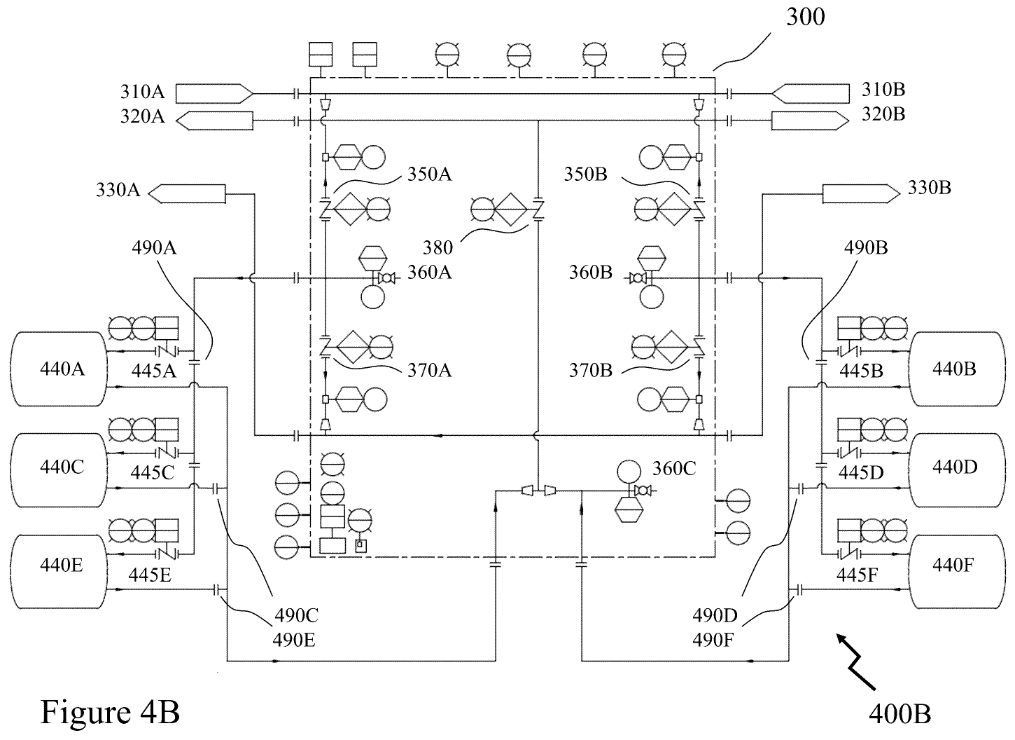

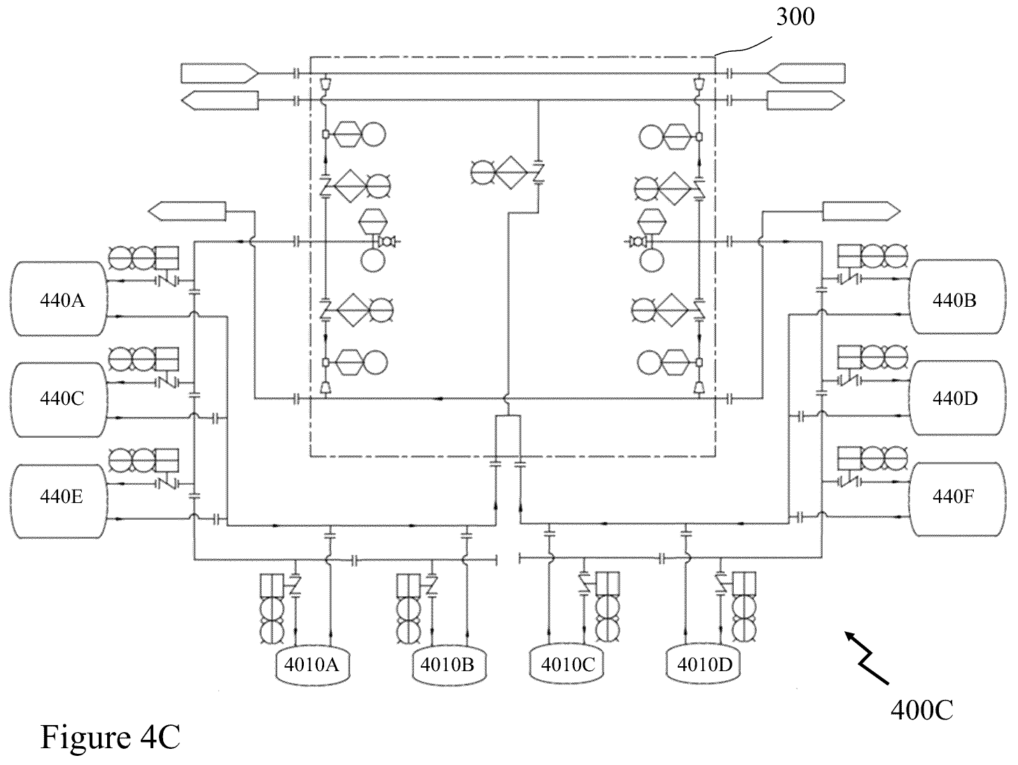

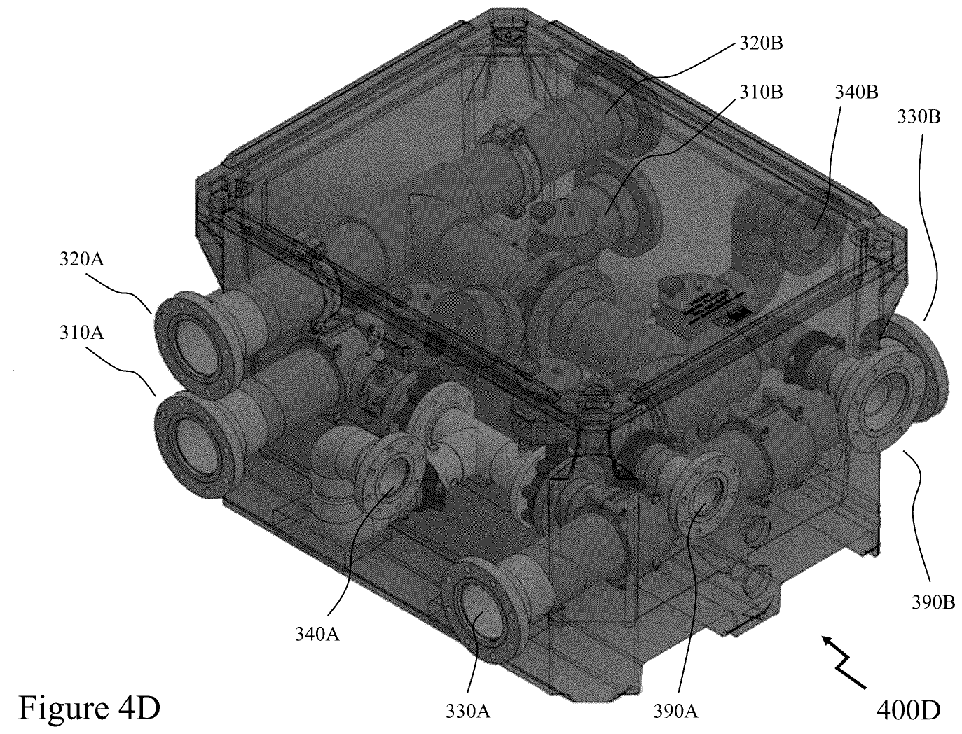

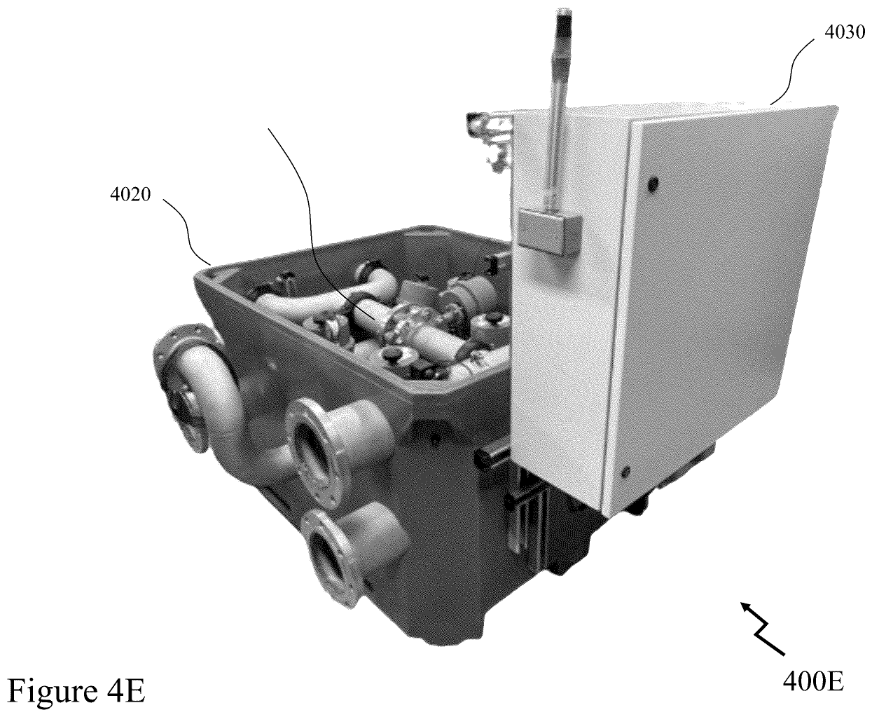

FIG. 4A depicts a 5-Valve Module 300 under a filtering operation for Filter Vessel A and Filter Vessel B. In this configuration, process fluid is fed through the inlet port 100A and travels through the automated valves and exits from valving module ports 112A and 116A and enters the vessel through the port 218 of Filter Vessel A for filtering. The filtered fluid then travels from the port 220 of Filter Vessel A and enters the 7-Valve Module 100 at port 114A for Filter Vessel A and port 110A for Filter Vessel B. In both instances the fluid flows to the filter outlet port 104A downstream processing.

FIG. 2B depicts the 7-Valve Module 100 under fluid backwashing of Filter Vessel A. In this configuration the fluid is fed through the inlet port 100A and travels from the valving module port 114A and enters the vessel port 220 to perform backwashing of the filter vessel, Filter Vessel A, where fluid then exits through port 218 of the Filter Vessel A and returns to the 7-Valve Module 100 through the 7-Valve Module 100 port 112A and travels to the waste fluid line and exit the module through the waste port 102A.

FIG. 2C depicts the 7-Valve Module 100 under fluid rinsing of Filter Vessel A. In this configuration, the fluid enters through inlet port 100A and exits from the vessel port 112A and enter the vessel through the top 218. The process fluid is then exiting from the bottom 220 and return to the valving module through the bottom port vessel A 114A and travel to the waste port 102A.

Accordingly, as described within FIGS. 1A to 2C a 7-Valve Module 100 as depicted in FIG. 1A can be employed with a pair of filters, e.g., Filter Modules 150 in FIG. 1B as described within PCT/CA2023/050569 entitled “Portable Insulated Water Treatment Modules and Systems for Purifying Water.” However, it would be evident that within many deployment scenarios designing and deploying a full system at initial installation results in higher initial costs and ongoing costs until full capacity is required. However, if that capacity is never reached then the system has been over-designed. Further, it would be beneficial if the complexity of the valve module could be reduced in order to allow for reduced costs.

Accordingly, the inventor has established as depicted in FIGS. 3 to 5 a reduced complexity five-valve valving module (5-Valve Module) 300 which supports a modular expansion of the filtering capacity of a filter system employing the 5-Valve Module 300 over time. As depicted in FIG. 3 the 5-Valve Module 300 in accordance with an embodiment of the invention comprises a first and second Inlet Ports 310A and 310B respectively corresponding to inlet port 100A of 7-Valve Module 100 in FIG. 1A, first and second Outlet Ports 320A and 320B respectively corresponding to outlet port 104A of 7-Valve Module 100 in FIG. 1A, and first and second Waste Ports 330A and 330B respectively corresponding to waste port 102A of 7-Valve Module 100 in FIG. 1A. Also depicted are first and second Filter Ports 340A and 340B which as will become evident in FIGS. 4A and 4B are coupled to the inlet(s) and outlet(s) of the filter pressure vessels, referred to as Filter Modules hereinafter, and first and second Ports 390A and 390B respectively which as will become evident in FIGS. 4A and 4B are coupled to the outlet(s) of the Filter Modules.

Within the 5-Valve Module 300 disposed between a connection between the first Inlet Port 310A and second Inlet Port 310B are to parallel fluid paths, first Fluid Path 3000A and second Fluid Path 3000B to a connection between the first Waste Port 330A and second Water Port 330B. The first Fluid Path 3000A comprises first Upper Valve 350A and first Lower Valve 370A where first Filter Port 340A is disposed between the first Upper Valve 350A and first Lower Valve 370A together with first Sample Port 360A. The second Fluid Path 3000B comprises second Upper Valve 350B and second Lower Valve 370B where second Filter Port 340B is disposed between second Upper Valve 350B and second Lower Valve 370B and second Sample Port 360B.

Disposed between first and second Outlet Ports 320A and 320B respectively is Central Valve 380 and third Sample Port 360C. Within embodiments of the invention the first Upper Valve 350A, first Lower Valve 370A, second Upper Valve 350B, second Lower Valve 370B and Central Valve 380 are electronically controllable valves (ECVs). Each ECV may incorporate at least one of a flowmeter and pressure meter (pressure gauge) and be coupled to a controller directly or indirectly. Alternately an ECV may be employed in conjunction with at least one of a flowmeter and pressure meter where these are coupled to ECV directly or indirectly through a controller. The controllers of the ECVs may each be coupled to different controllers, to a number of controllers or to a common controller. These controllers may form part of the 5-Valve Module 300 or they form part of a controller external to the 5-Valve Module 300. Whilst these flowmeters and pressure meters associated with the ECVs are depicted in FIG. 3 together with other fluid control elements, which may include flowmeters and pressure meters, are depicted these are not identified for the sake of clarity as their presence or absence does not change the functionality and design of the 5-Valve Module 300. The 5-Valve Module 300 also include, but similarly not identified for clarity, dry contacts for external fluidic elements such as pumps, alarm contacts for external alarms, control contacts for shutdown, audiovisual indicators and switch contacts for example.

Now referring to FIG. 4A there is depicted a Filter System 400A wherein the 5-Valve Module 300 in accordance with an embodiment of the invention is employed in a first configuration with a pair of filter modules; first and second Filter Modules 440A and 440B respectively in conjunction with additional fluidic circuit elements. First Filter Module 440A is employed in conjunction with first External Valve 445A which may be integrated within first Filter Module 440A or external to the first Filter Module 440A. Similarly, second Filter Module 440B is employed in conjunction with second External Valve 445B which may be integrated within first Filter Module 440B or external to the first Filter Module 440B. The input ports of each of the first and second Filter Modules 440A and 440B being coupled to first and second Filter Ports 340A and 340B respectively whilst the output ports of each of the first and second Filter Modules 440A and 440B being coupled to first and second Ports 390A and 390B, respectively.

Whilst Filter System 400A is depicted as comprising first and second Filter Modules 440A and 440B this forms the basis of Filter System 400B depicted in FIG. 4B. Accordingly, Filter System 400A in FIG. 4A has first to sixth Flanges 490A to 490F respectively which are blanked so that fluid flow is only through the first and second Filter Modules 440A and 440B respectively. Further, a variant of Filter System 400A may employ a single filter module such that variants of the filter system with 5-Valve Module 300 may employ a single filter module, a pair of filter modules (FIG. 4A), three filter modules, four filter modules, five filter modules and six filter modules (FIG. 4B. Further, if additional flanges are provided additional filter modules can be supported. If a single filter module is employed then a connection from the other output port of the 5-Vale Module 300 to the other of the first and second Ports 390A and 390B respectively should be made.

The 5-Valve Module 300 of Filter System 400A may be employed in filtering and backwash modes. In filtering mode, the system can operate in three different configurations. In the first configuration considering first Filter Module 440A first Upper Valve 350A is open, first Lower Valve 370A is closed and Central Valve 380 open such that fluid flow is through from the inlet, one or both of first and second Inlet Ports 310A and 310B respectively, via first Upper Valve 350A to the first Filter Module 440A and therein to the 5-Valve Module 300 outlet, one or both of first and second Outlet Ports 320A and 320B respectively, via the Central Valve 380. In the second configuration considering second Filter Module 440B second Upper Valve 350B is open and second Lower Valve 370B is closed such that fluid flow is through from the inlet, one or both of first and second Inlet Ports 310A and 310B respectively, via second Upper Valve 350B to the second Filter Module 440B and therein to the 5-Valve Module 300 outlet, one or both of first and second Outlet Ports 320A and 320B respectively, via the Central Valve 380. In the third configuration the 5-Valve Module 300 of Filter System 400A concurrently operates in the first and second configurations such that fluid is coupled to both the first Filter Module 440A and the second Filter Module 440B.

In backwash mode then there are two configurations, one for backwashing the first Filter Module 440A and the second for backwashing the second Filter Module 440B. In the first configuration the first Upper Valve 350A is closed, first Lower Valve 370A open, second Upper Valve 350B open, second Lower Valve 370B is closed and Central Valve 380 closed such that fluid flow is through from the inlet, one or both of first and second Inlet Ports 310A and 310B respectively, via second Upper Valve 350B to the second Filter Module 440B and therein to the outlet of the first Filter Module 440A as the Central Valve 380 is closed. From first Filter Module 400A the flow proceeds via first Lower Valve 370A as first Upper Valve 350A is closed and therein to one or both of first and second Exhaust Ports 330A and 330B, respectively. In this manner the first Filter Module 440A is backwashed with fluid that has been filtered by second Filter Module 440B.

In the second configuration the first Upper Valve 350A is open, first Lower Valve 370A closed, second Upper Valve 350B closed, second Lower Valve 370B is open and Central Valve 380 closed such that fluid flow is through from the inlet, one or both of first and second Inlet Ports 310A and 310B respectively, via first Upper Valve 350A to the first Filter Module 440A and therein to the outlet of the second Filter Module 440B as the Central Valve 380 is closed. From second Filter Module 400A the flow proceeds via second Lower Valve 370B as second Upper Valve 350B is closed and therein to one or both of first and second Waste Ports 330A and 330B, respectively. In this manner the second Filter Module 440B is backwashed with fluid that has been filtered by first Filter Module 440A.

It would be evident that the 5-Valve Module 300 does not support a forward flowing rinse mode as there is no connection from the outlets of the first and second Filter Modules 400A and 400B to the one or both of first and second Waste Ports 330A and 330B, respectively. However, a reverse flow rinse can be supported in a similar configuration to that of the backwashing wherein the flow rate is reduced through the Fluid System 400A in rinse mode relative to the backwashing.

However, it would be evident that such functionality may be implemented by addition of a fluidic switch such that the forward path from the first and second Ports 390A and 390B respectively, which are coupled to the outlets of the first and second Filter Modules 400A and 400B respectively, can be coupled to either the Central Valve 380 or can be switched to the waste path between the one or both of first and second Waste Ports 330A and 330B respectively. Alternatively, additional external valving/switching on each filter module may provide a dump port to a waste such as that coupled to one or both of the first and second Waste Ports 330A and 330B respectively or another fluidic waste sink etc.

Now referring to FIG. 4B there is depicted Fluidic System 400B wherein the 5-Valve Module 300 in accordance with an embodiment of the invention is shown in a second configuration with six filter modules. Accordingly, Fluidic System 400B has third Filter Module 440C coupled to the first Flange 490A at its input and the third Flange 490C at its output and fourth Filter Module 440D coupled to the second Filter Module 440B at its input and fourth Flange 490D at its output. Fifth Filter Module 440E is coupled to the inlet of the third Filter Module 440C before the third External Valve 445C at its input and fifth Flange 490E at its output whilst sixth Filter Module 440F is coupled to the inlet of the fourth Filter Module 440D before the fourth External Valve 445D at its input and sixth Flange 490F at its output. Each of the fifth and sixth Filter Modules 440E and 440F having fifth and sixth External Valves 445E and 445F, respectively.

Accordingly, by appropriate control of the first Upper Valve 350A, first Lower Valve 370A, second Upper Valve 350B, second Lower Valve 370B and Central Valve 380 in a manner similar to that described above in respect of FIG. 4A and Fluidic System 400A then the Fluidic System 400B can be employed to filter through the one or more of the first to sixth Filter Modules 440A to 440F. Which filter modules of the one or more of the first to sixth Filter Modules 440A to 440F being employed is established in dependence upon the settings of the first to sixth External Valves 445A to 445F, respectively. As such the Fluidic System 400B has the three configurations described with respect to Fluidic System 400A but with each configuration having sub-configurations according to which of the first to sixth Filter Modules 440A to 440F are employed.

Similarly, Fluidic System 400B can be configured to backwash the one or more of the first to sixth Filter Modules 440A to 440F based upon the by appropriate control of the first Upper Valve 350A, first Lower Valve 370A, second Upper Valve 350B, second Lower Valve 370B and Central Valve 380 in a manner similar to that described above in respect of FIG. 4A. Further, which filter modules on each side are backwashed and which provide filtered water for the backwash process can be established in dependence upon the appropriate control of the first to sixth External Valves 445A to 445F, respectively. Likewise, a reverse flow rinse is supported within Fluid System 400B as depicted or a forward flow rinse can be supported based upon the configuration changes described and depicted with respect to Fluid System 400A in FIG. 4A.

It would be evident that according to the design of the 5-Valve Module 300 in terms of its capacity and the available fluid flow at the inlet(s) and the specifications of the filter modules that the design depicted in FIG. 4B may be extended to a Fluidic System 400A as depicted in FIG. 4C wherein first to fourth Filter Processing Modules 4010A to 4010D are depicted in addition to the first to sixth Filter Modules 440A to 440F respectively such that the 5-Valve Module is operating in conjunction with 10 filter elements overall. The design of a Filter Module or Filter Processing Module may be similar to that of a filter module such as depicted in FIG. 1B. Within other embodiments of the invention a Filter Module or Filter Processing Module may be replaced with another module including, but not limited to, a pump module, a sludge extraction module, a desalination module and an aerator.

Referring to FIG. 4D there is depicted a three-dimensional (3D) perspective view of a 5-Valve Module 400D according to an embodiment of the invention showing the first and second Inlet Ports 310A and 310B respectively, the first and second Outlet Ports 320A and 320B respectively, the first and second Waste Ports 330A and 330B respectively, the first and second Filter Ports 340A and 340B respectively and the first and second Ports 390A and 390B respectively. The first Inlet Port 310A, first Outlet Port 320A and the first Waste Port 330A are depicted as being on an opposing sides of the 5-Valve Module 400D to the second Inlet Port 310B, the second Outlet Port 320B and second Waste Port 330B allowing the 5-Valve Module 400D to be connected in series to other 5-Valve Modules 400D or other valving modules such as 7-Valve Module 100 in FIG. 1A. The first and second Filter Ports 340A and 340B are similarly depicted as being on opposing sides whilst the first and second Ports 390A and 390B respectively are on another face of the 5-Valve Module 400D. However, within other embodiments of the invention the first and second Filter Ports 340A and 340B may be on the same face as the first and second Ports 390A and 390B respectively or another face of the 5-Valve Module 400D.

Whilst FIG. 4D depicts a 5-Valve Module it would be evident that the design relative to that of FIG. 1 which is a 7-Valve Module whist providing the same ports has been reconfigured as well as removing a pair of valves such that the 5-Valve Module is easier for servicing as well as initial fabrication thereby lowering the initial and lifetime costs.

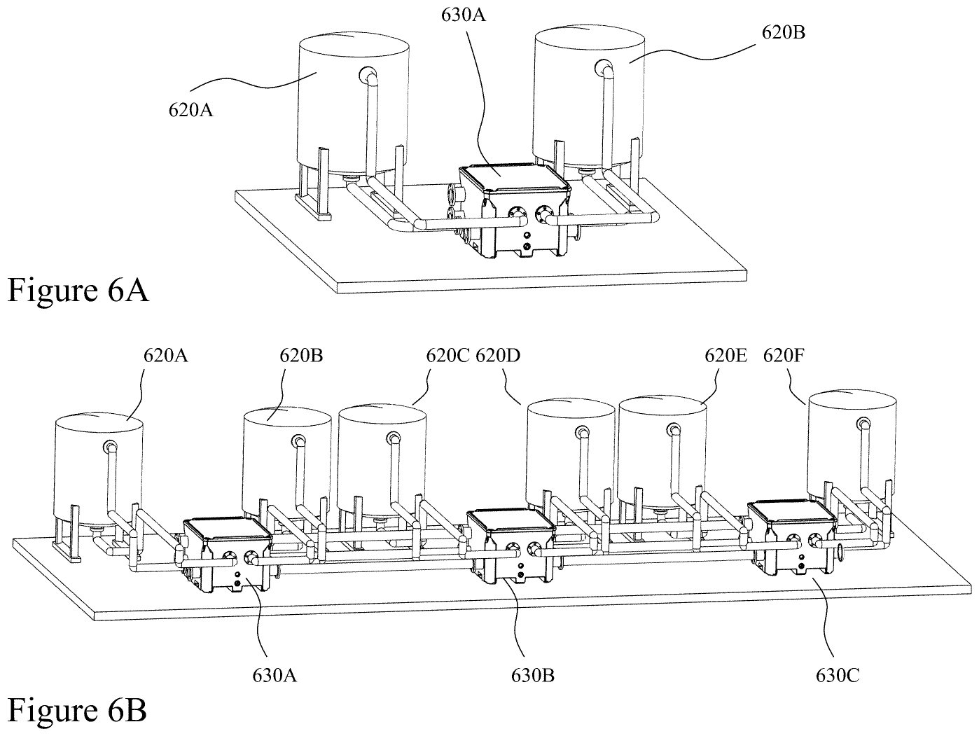

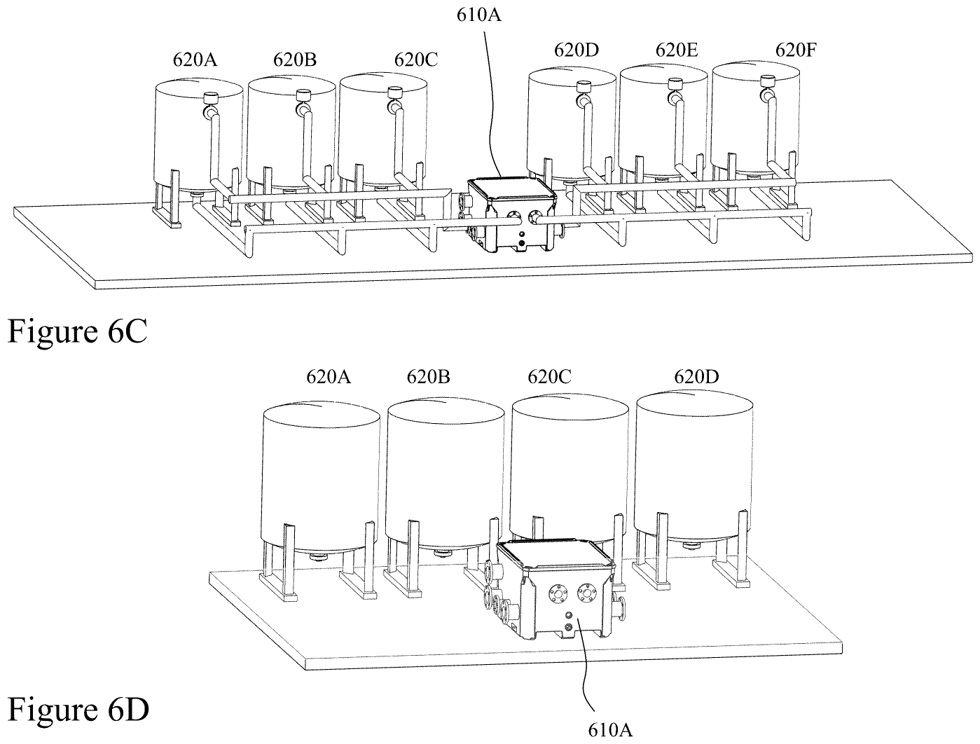

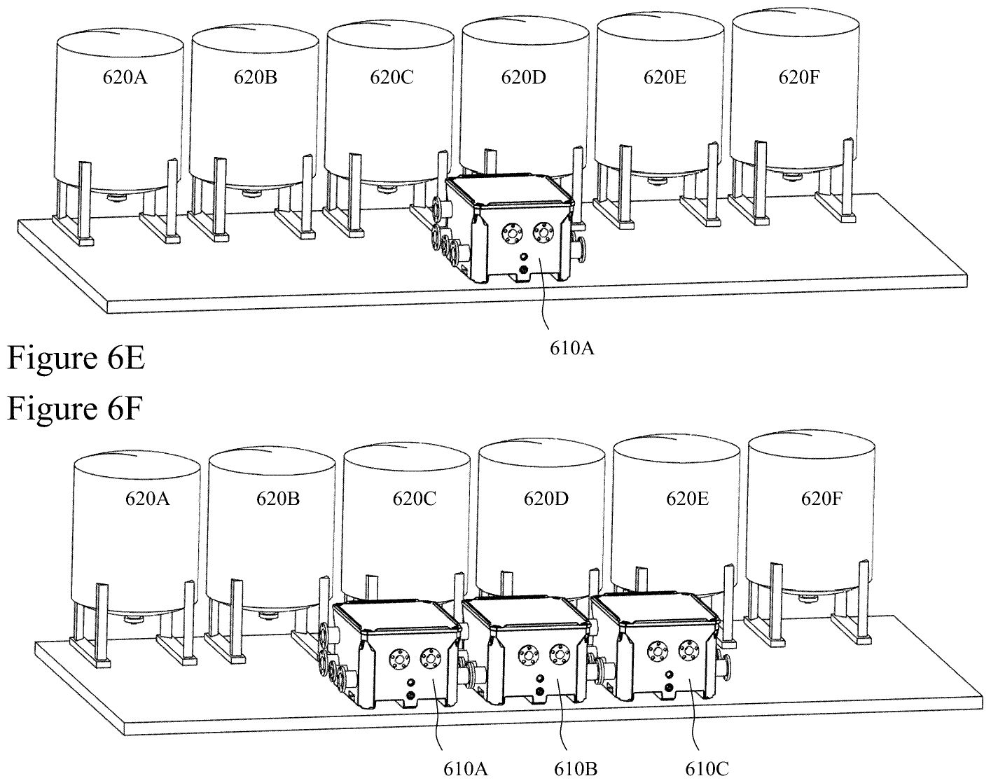

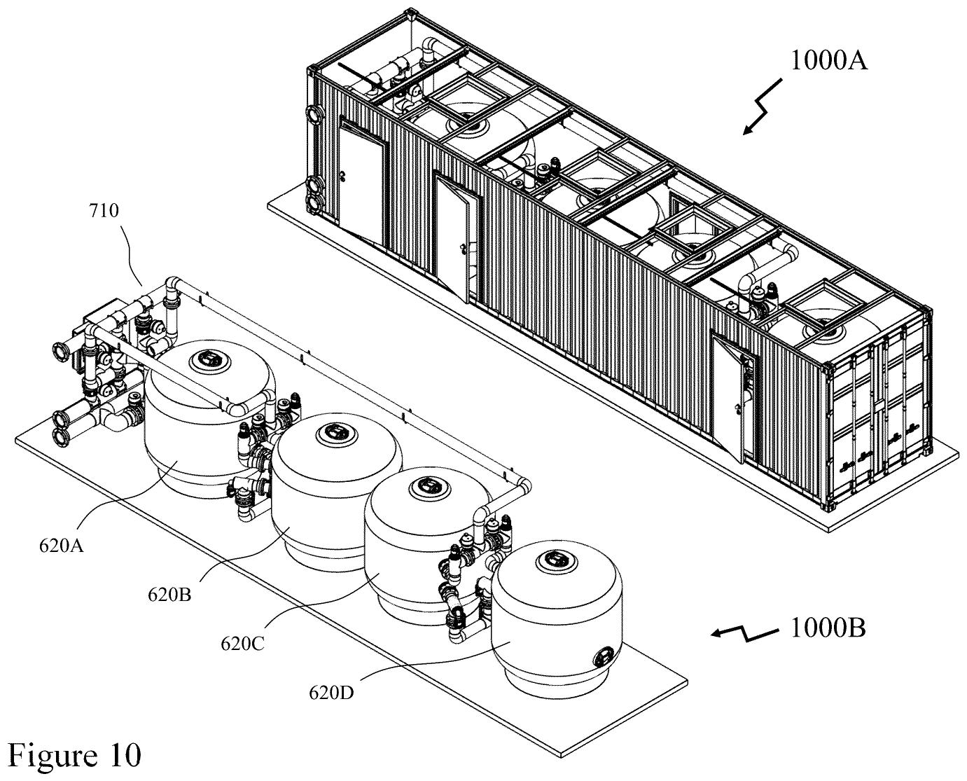

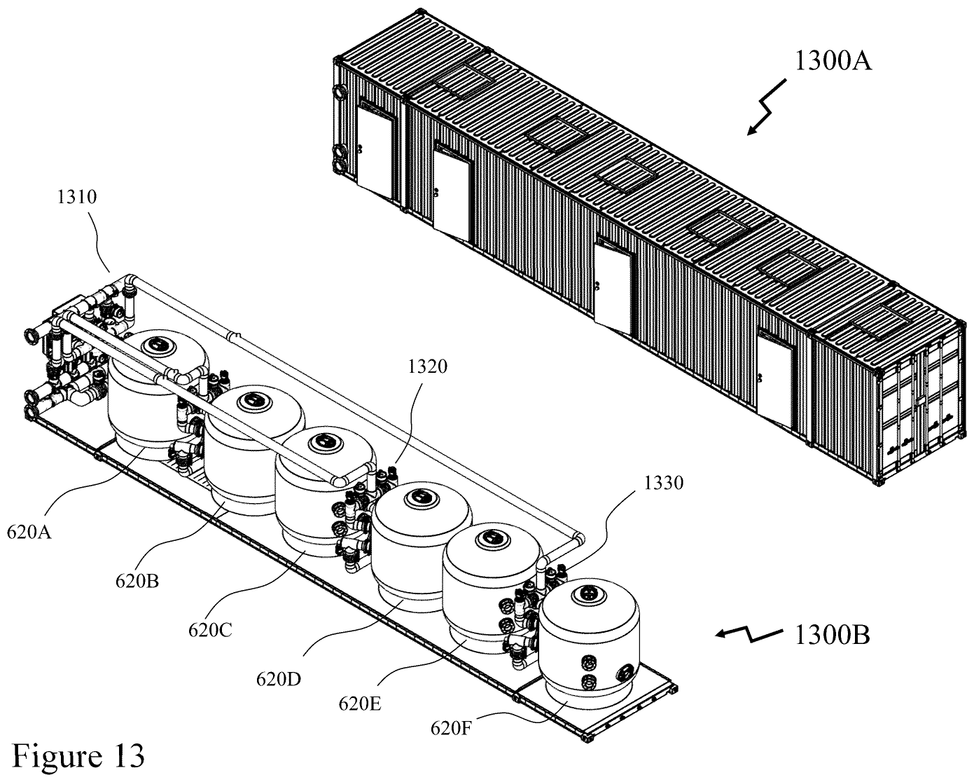

Now referring to FIG. 4E there is depicted a 3D perspective view of a 5-Valve Module 400E wherein the Valve Array 4010 is depicted disposed within a Container 4020 and with an Automatic Control Panel (ACP) 4030. The Container 4020 provides a self-contained Valve Module with environment protection for deployment as shown in FIGS. 6A to 6F. The Valve Array 4010 may employ a design such as depicted in FIGS. 4A to 4C respectively. Alternatively, the Valve Array 4010 may be deployed within an enclosure with the filter modules such as depicted in FIGS. 10 and 13.

The Container 4020 may include a temperature controlled heating system to prevent the temperature dropping below a defined setpoint and/or a sump alarm switch to warn the operator of a leak or accumulation of liquid within the Container 4020. The ACP 4030 may be interfaced to a GFCI protected plug allowing the ACP 4030 to be connected to a power supply such as an electrical mains, a battery and a generator.

The ACP 4030 is coupled to the Valve Array 4010 such that it can provide control signals to the electronically controlled valves (ECVs), both the ON/OFF valves and modulating valves according to the design of the valve module. The ACP 4020 is also coupled to the Valve Array 4010 such that it can receive data from sensors/transmitters associated with the flowmeters and optionally pressure meters and other sensors to ensure the flow limits are not reached for the filter modules, or other fluid processing modules (FPMs), coupled to the Valve Array 4010. The flowmeters and optional pressure meters may form part of a single module with an ECV, be coupled to an ECV and thereby the ACP 4030 or coupled to the ACP 4030 discretely. The ACP 4020 may provide the required control to ensure that upstream and downstream control devices are operating within a safe range or it may solely control the Valve Array 4010.

The ACP 4020 within an embodiment of the invention employs a dedicated programmable logic controller (PLC) based control system allowing it to operate as an independent system or it can be linked with other ACPs 4020 associated with other Valve Modules 4010 or FPMs allowing the ACP 4020 to form part of a more complex, integrated, and automated fluid (such as water) treatment processes or systems.

The PLC within the ACP 4030 can create proportional integral derivative loops to regulate the flow within the Valve Array 4010 and/or the FPVs coupled to the Valve Array 4010. The ACP 4020 may exploit adjustable setpoints which are set by an operator via a Human Machine Interface (HMI) allowing the operator to adjust the setpoints based upon the type of FPVs the ACP 4030 is connected to and controlling. The HMI may be part of the ACP 4030 or may be associated with the operator and connected to the ACP 4030.

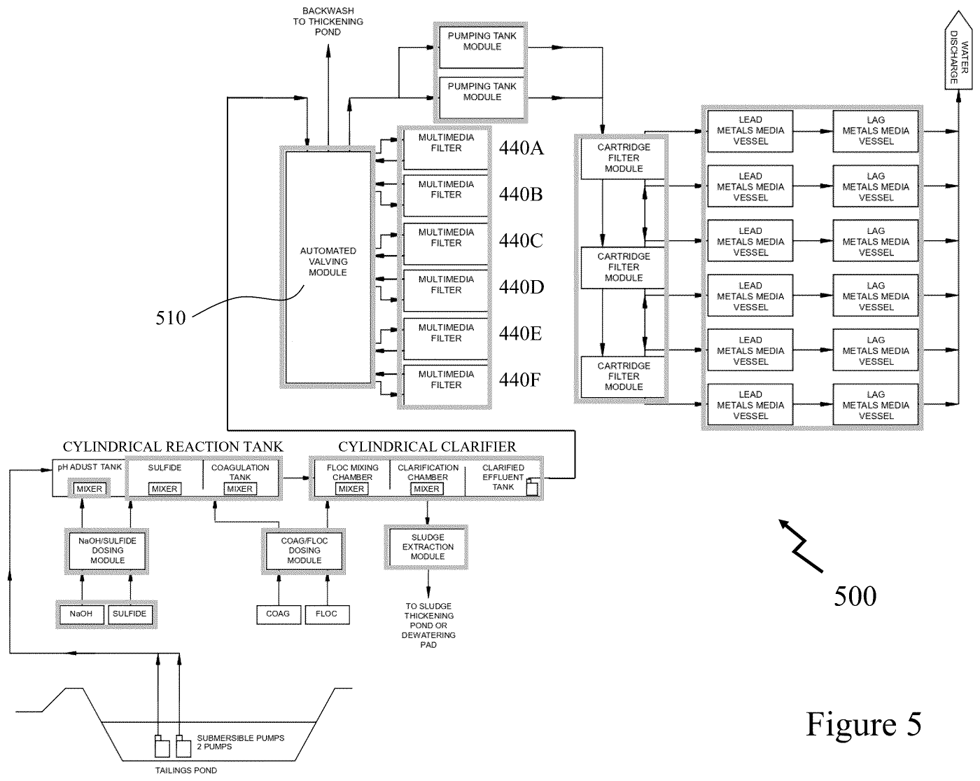

Referring to FIG. 5 there is depicted an exemplary deployment Scenario 500 of a 5-Valve Module according to an embodiment of the invention for processing mine tailings. Accordingly, the 5-Valve Module being Automated Valving Module 510 is depicted deployed after an initial processing stage ad prior to a final filtering stage. The Automated Valving Module 510 being connected to first to sixth Filters 440A to 440F as depicted in FIG. 4B. With each of the first to sixth Filters 440A to 440F capable of handling 200 gallons per minute (GPM) the combination of first to sixth Filters 440A to 440F and Automated Valving Module 510 using the 5-Valve Module concept can process 1200 GPM of mine water.

Accordingly, it would be evident that a 5-Valve Module can be used to automatically direct flow of process water into filters or other modules, e.g., multimedia filters, for processing. The valves within the 5-Valve Module can also direct the flow to complete backwashing cycles. The 5-Valve Module has the ability to direct and limit the flow based on readings from flow transmitters monitoring the inlet flow. The valves modulate to limit the flow into the multimedia filters. On a backwash cycle, the valves will open to the waste line. A backwash cycle can be set on a timer to be completed automatically or established in dependence upon other criteria such as monitoring the outlet of the 5-Valve Module for example.

An automated control panel may provide for local and/or remote control of the On/Off and modulating valves within the 5-Valve Module according to the signals from the flow transmitters within the 5-Valve Module, to ensure the flow limits are not reached for the multimedia filters. Other control may be implemented to ensure upstream and down-stream control devices are operating within a safe range. Optionally control may also be adjusted and/or established in dependence upon the readings acquired from one or more sensors associated with the 5-Valve Module or providing readings to the 5-Valve Module directly or indirectly or to a remote control system.

The 5-Valve Module may include a dedicated PLC control system to allow it to operate as an independent treatment system, or it can be linked with other 5-Valve Modules on site or with other equipment and/or a remote control system. The quick and easy connections of the 5-Valve Module with other 5-Valve Modules allows for the formation of complex, integrated, and automated water treatment processes.

The integral PLC is able to create proportional integral derivative loops to regular the flow into the multimedia filters. These may be defined automatically at installation or within other embodiments of the invention the PLC may learn and adapt these using one or more machine learning processes and/or one or more artificial intelligence processes. Adjustable setpoints may be implemented on a human-machine interface rendered to an operator upon a PED or FED to adjust aspects of the 5-Valve Module based on the type of multimedia filter installed in the process.

The 5-Valve Module enclosure may be equipped with a temperature controlled heating system and/or a sump pump and/or a sump alarm switch. The sump pump or alarm being to address any leak or accumulation of liquid within the enclosure of the 5-Valve Module. The 5-Valve Module is connected to one or more electrical power supplies via GFCI interface. In the instance of a modular filter system rapidly portable and installed then these electrical connections may be via GFCI protected plugs.

The 5-Valve Module 300 as described and depicted incorporates a series of electronically controlled valves together with flow meters, other valves to allow samples from the first to third Sampling Ports 360A to 360C and other ancillary fluidic circuit elements such as pressure gauges as well as electronic interfaces for receiving control signals, generating control signals to other elements of an installation of which the 5-Valve Module 300 forms part, generating alarm signals etc. These control signals, alarm signals etc. may be communicated from elements of the fluidic circuit to a controller or controllers of the 5-Valve Module and overall system it forms part of via one or more wired interfaces according to one or more wired standards and/or one or more wireless interfaces operating according to one or more wireless standards.

FIG. 6A to 6F depict configurations comprising one or more 5-Valve Modules (5VMs) according to embodiments of the invention with varying numbers of fluid processing vessels (FPVs) such as a filter or filtration module, chemical dosing module, sedimentation module, algae scrubber module, desalination module and an ultraviolet treatment module for example. Within each of FIGS. 6A to 6C the interconnecting fluidic connections between the VMs and FPVs are depicted whilst the overall input and output connections to the external fluidic environment are not depicted without any input and output connections to the external fluidic environment or between the VMs and FPVs.

Within FIGS. 6D to 6F the 5VMs and FPVs are depicted without any connections for clarity. Accordingly, there are depicted:
FIG. 6A wherein a first 7-Valve Module (7VM) 630A is coupled to first and second FPVs 620A and 620B respectively such that only 2 FPVs are connected to the 7VM;
FIG. 6B wherein expansion using the 7VM such as described within PCT/CA2023/050569 requires replication of the configuration of FIG. 6A such that to provide 6 FPVs the configure requires a first 5VM 610A is coupled to first and second FPVs 620A and 620B, a second 5VM 620B is coupled to third and fourth FPV's 620C and 620D, and a third 5VM 620C is coupled to fifth and sixth FPVs 620E and 620F but still limiting the FPVs per 5VM to two;
FIG. 6C wherein a first 5VM 610A is coupled to first to sixth FPVs 620A to 620F whereby the addition of additional field mounted valves to each FPV (which are visible at the top of each FPV) then the 6 FPVs can run on only one 5VM thereby reducing the cost to treat higher water volumes;
FIG. 6D wherein a first 5VM 610A is coupled to first to fourth FPVs 620A to 620D in a similar manner to that depicted in FIG. 6C where the additional field mounted valves for each FPV are omitted for clarity but it is evident that the 5VM can be configured to operate initially with 2 or 4 FPVs and expandable to 4 or 6 FPVs respectively;
FIG. 6E wherein a first 5VM 610A is coupled to first to sixth FPVs 620A to 620F in a similar manner to that depicted in FIG. 6C;
FIG. 6F wherein first to third 5VMs 610A to 610C are directly coupled to each other where the first VM 610A is coupled first to third FPVs 620A to 620C respectively and third 5VM 610C is coupled to fourth to sixth FPVs 620D to 620E respectively.

Accordingly, it is evident comparing the design of FIG. 6B using the prior art 7VM to that of FIG. 6C with the 5VM according to an embodiment of the invention that the new 5VM provides for reduced cost by replacing 3 valve modules with a single valve module.

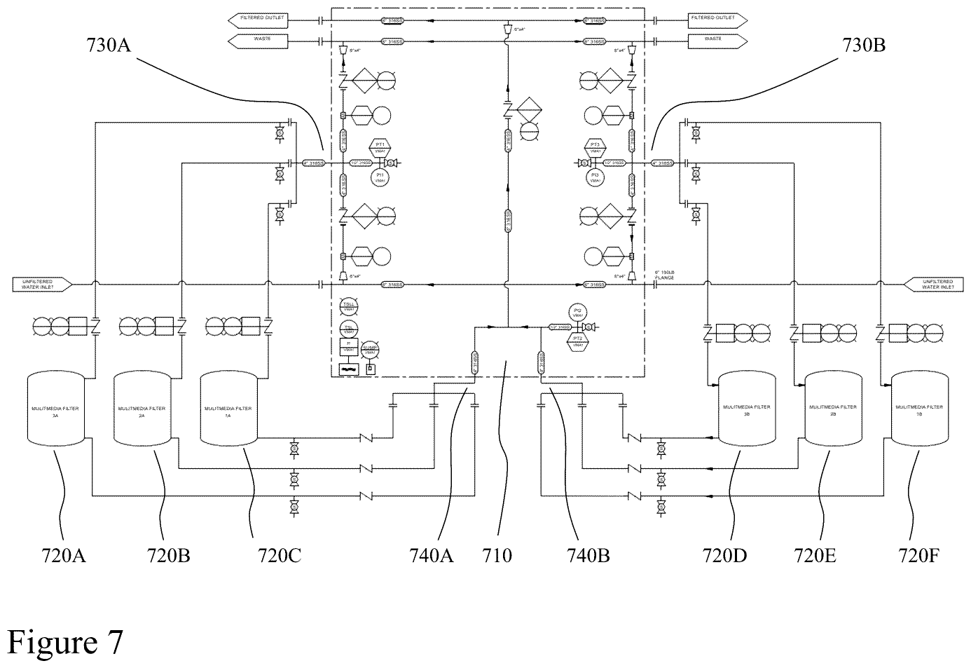

Now referring to FIG. 7 there is depicted a schematic of the interconnections between 5VM 710 in accordance with an embodiment of the invention in a configuration with first to sixth FPVs 720A to 720F respectively in a manner such as depicted in FIG. 6E. Accordingly, first to third FPVs 720A to 720C are coupled between first Output Port 730A and first Input Port 740A whilst fourth to six FPVs 720D to 720F are coupled between second Output Port 730B and second Input Port 740B. This being a variant configuration of a Filter System 400B depicted in FIG. 4B.

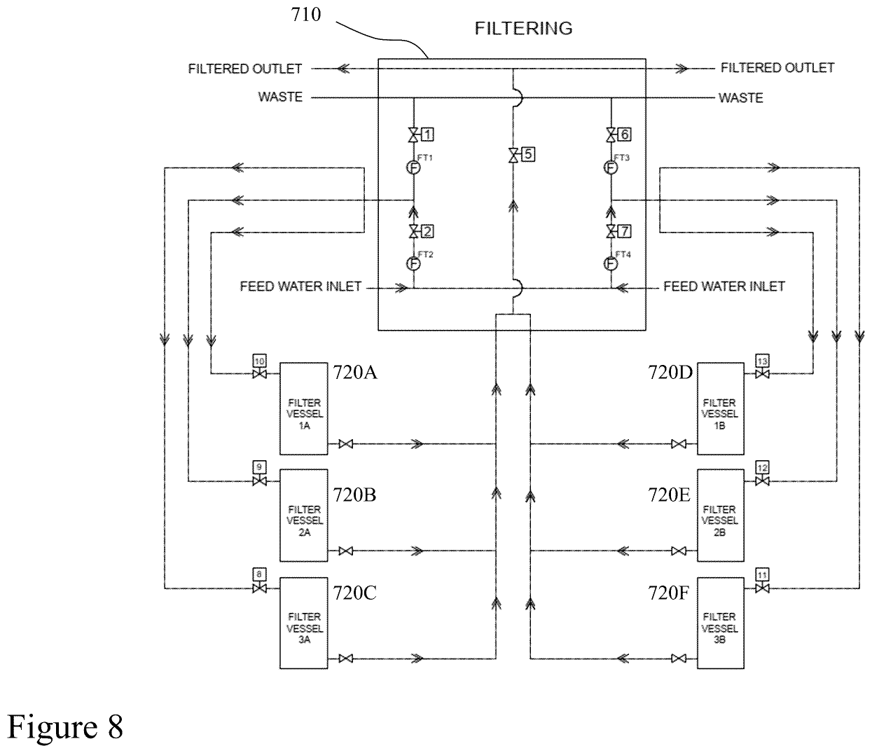

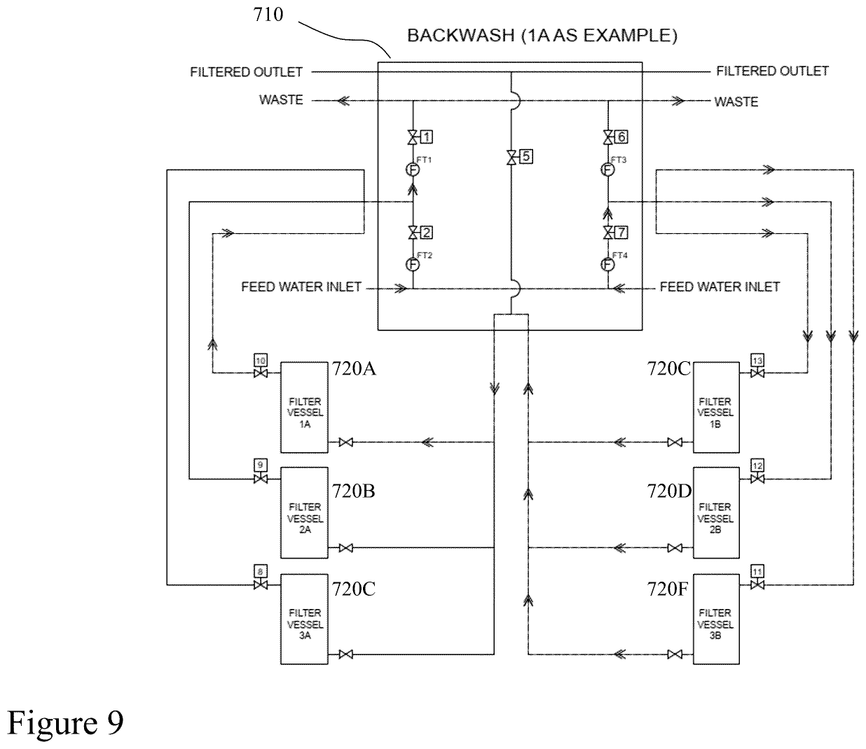

Referring to FIGS. 8 and 9 there are depicted the configurations of FIG. 7 under the operational modes of filtering (FIG. 8) and backwashing one of the filter vessels, first FPV 720A, to show the flow directions in each operational mode.

Now referring to FIG. 10 there is depicted an exemplary mobile deployment of a 5-Valve module with 4 filter vessels according to an embodiment of the invention integrated within a standard 40 foot container in a configuration such as depicted in FIG. 6E. First Image 1000A depicts the 40 foot shipping container (length 12.19 m) disposed around the fluidic assembly mounted upon the ground. Doors within the side of the container are depicted but may be omitted or in different positions, different count etc. in other configurations. The top shell of the container has been omitted to show frame and skylights etc. and the internal fluidic assembly. Second Image 1000B depicts the 5VM 710 disposed at one end of the container with the four FPVs 620A to 620D disposed along the length of the container. Also visible in first Image 1000A are the external fluidic connections for feed water inlet, filtered outlet and waste where these are mirrored on the other hidden side of the container.

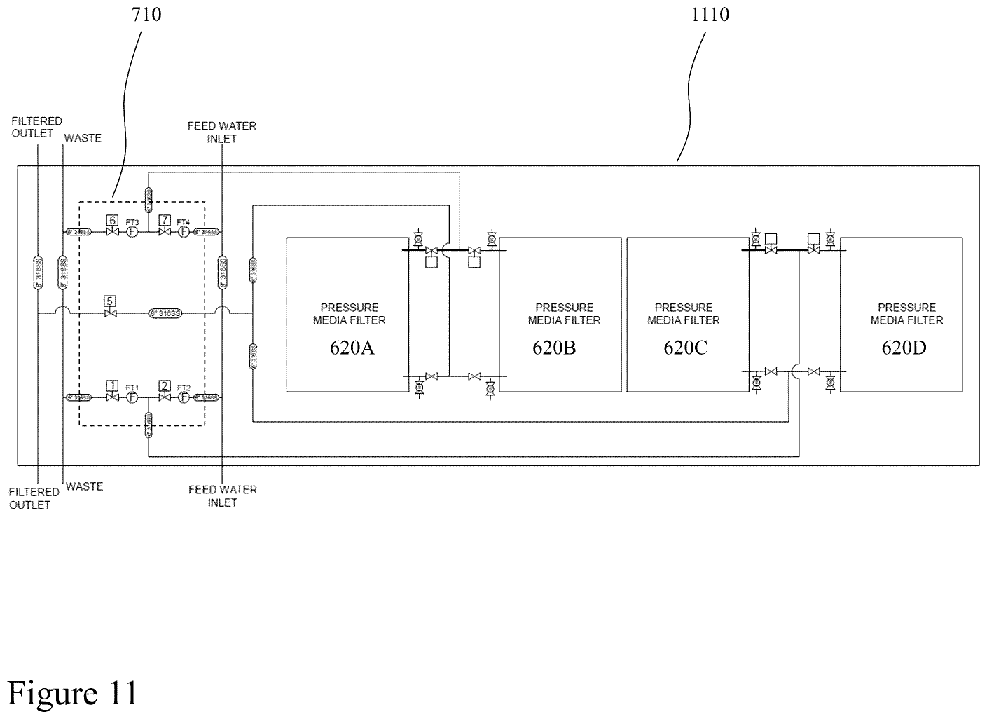

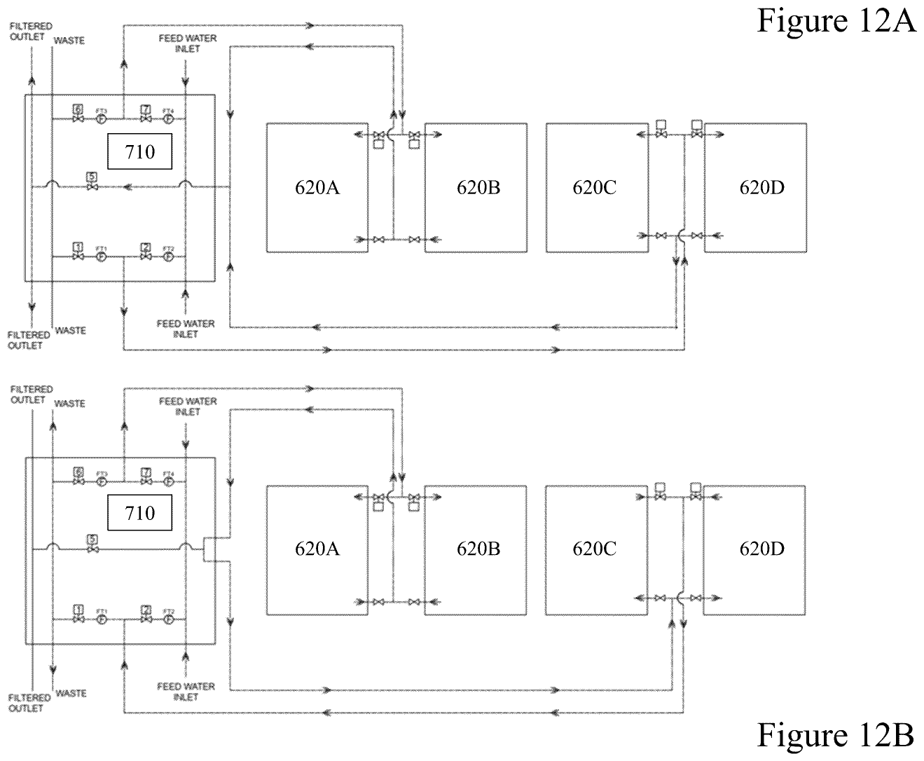

Referring to FIG. 11 there is depicted schematically the configuration of FIG. 10 where FIGS. 12A and 12B depict the configuration of FIG. 11 under the operational modes of filtering (FIG. 12A) and backwashing (FIG. 12B) to show flow directions. Within FIG. 11 the 5VM 710 and four FPVs 620A to 620D are depicted disposed along the length of the Container 1110. The reduced footprint of the 5VM 710 allows for larger FPVs within the Container 1110.

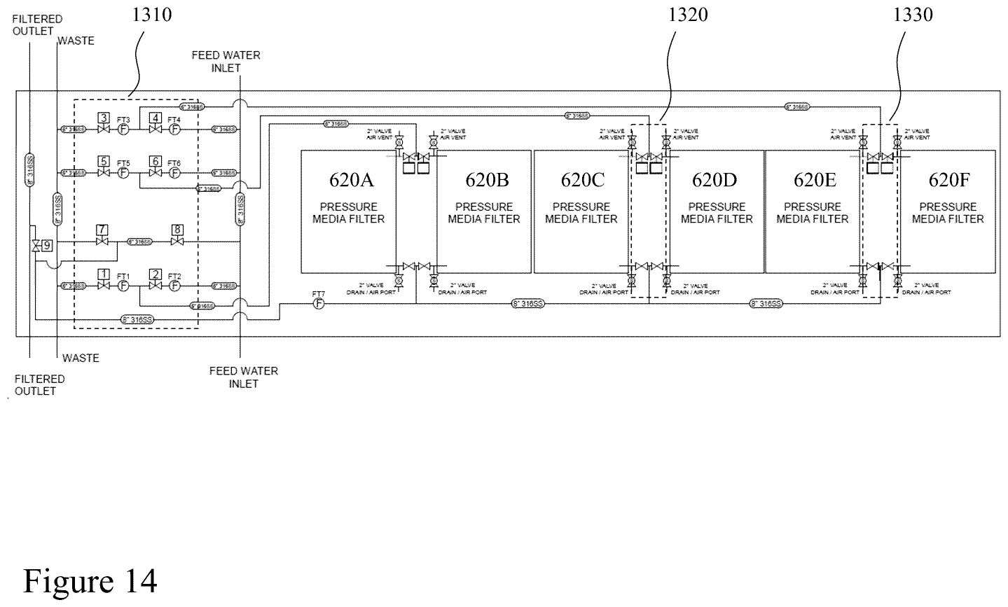

Now referring to FIG. 13 there is depicted an exemplary mobile deployment of a 7-Valve module with 6 filter vessels according to an embodiment of the invention integrated within a standard 53 foot container in a configuration such as depicted in FIG. 6E. First Image 1300A depicts the 53 foot shipping container (length 16.15 m) disposed around the fluidic assembly mounted upon the ground. Doors within the side of the container are depicted but may be omitted or in different positions, different count etc. in other configurations. The top shell of the container has been omitted to show frame and skylights etc. and the internal fluidic assembly. Second Image 1300B depicts the Valve Module 1310 disposed at one end of the container with the six FPVs 620A to 620F disposed along the length of the container together with Intermediate Valving Modules 1320 and 1330 respectively. Also visible in first Image 1000A are the external fluidic connections for feed water inlet, filtered outlet and waste where these are mirrored on the other hidden side of the container. Referring to FIG. 14 there is depicted schematically the configuration of FIG. 13.

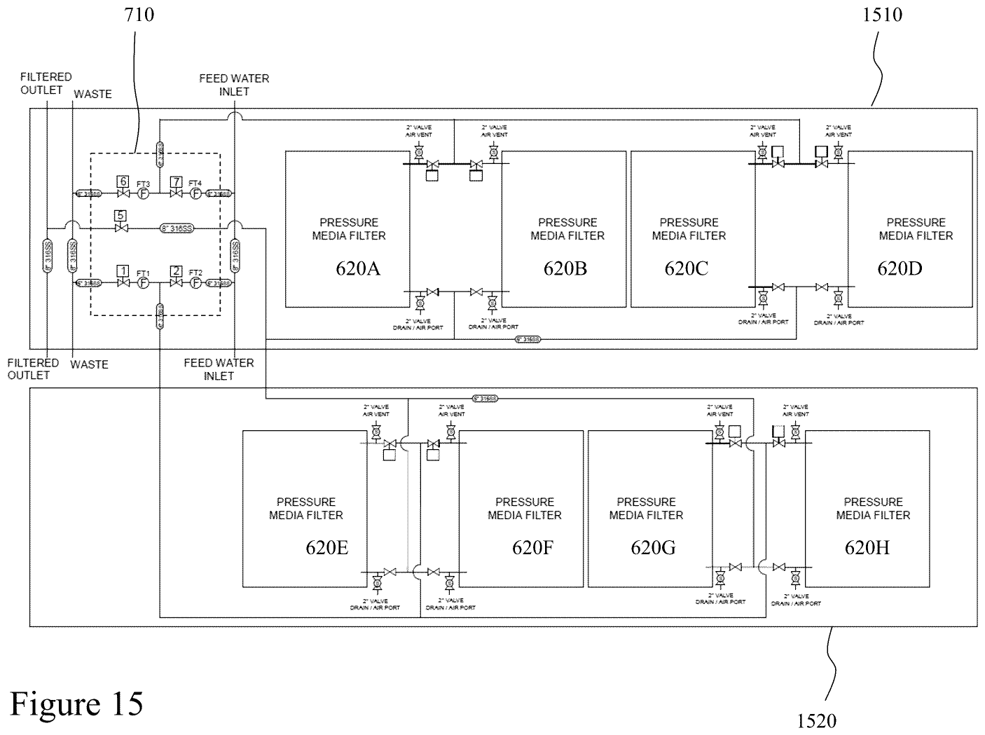

Referring to FIG. 15 there is depicted an exemplary mobile deployment of dual 4 filter vessel arrays according to an embodiment of the invention where each 4 filter vessel array is integrated within a standard 40 foot container. Accordingly, there are depicted first and second Containers 1510 and 1520. First Container 1510 being as depicted in first Image 1000A in FIG. 10 wherein a 5VM 710 is coupled to first to fourth FPVs 620A to 620D on one side of the 5VM 710. A second Container 1520 comprising the fifth to eighth FPVs 620E to 620H is coupled to the other side of the 5VM 710 within the first Container 1510.

Whilst the embodiments of the invention described and depicted in FIGS. 6A to 15 are described as employing 5-valve modules it would be evident that within other embodiments of the invention one of more 5-valve modules may be replaced with a 7-valve module.

As evident from FIGS. 6A to 15 a number of fluid processing vessels (FPVs) are disposed external to the 5-valve module (5VM), or 7-valve module, where each FPV requires only one automated on/off valve on the inlet to each of the FPVs to expand the flow capacity for a lower cost. The single valves mount on the FPV and tie into the module with quick connects. In this manner designs can be configured such that there are 2 or more parallel trains of 2 or 3 FPVs which all run on one module. By appropriate sizing of the piping within the 5VM then designs as evident from the description above then, for example 4 or 6 external FPVs with the automated backwashing without having to add so many automated valves keeping the module compact. The number of valves now becomes 5+N valves, for N FPVs, such that only 9 valves are required for a feedwater backwash compared to 20 valves with a conventional feedwater backwash system. Further, by this design methodology the treatment flow can be 1000 gallons (US) per minute (USgpm) rather than 400 to 500 USgpm of prior designs.

Consider the design depicted in FIG. 10 then first to fourth FPVs may be 88″ (2.24 m) FPVs where a total treatment flow rate of 1200 USgpm is supported where the valve module is easily mounted to the wall of the container with 8″ (200 mm) header lines and 6″ (150 mm) filter feed lines to accommodate this treatment capacity.

It would be evident that the designs depicted in FIGS. 10 to 15 by exploiting premanufactured and automated filtration system elements can be rapidly deployed where the container that support standard shipping/loading/unloading etc. In cold weather environments the containers may include insulation or have internal heaters which can be connected to a power source such as external generator etc. A 40 foot container or 52 foot container may be shipped by road, trail or sea with ease.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A device comprising:
an inlet comprising at least a pair of inlet ports for receiving a fluid from a first part of a fluidic system;
an outlet comprising at least a pair of outlet ports for providing a processed portion of the fluid to a second part of the fluidic system;
an exhaust comprising at least a pair of exhaust ports for providing another processed portion of the fluid to another fluidic system;
a filter port of a pair of filter ports for receiving the fluid from the inlet and coupling it to one or more modules of a first set of processing modules;
another filter port of the pair of filter ports for receiving the fluid from the inlet and coupling it to one or more modules of a second set of processing modules;
a port for receiving the processed portion of the fluid from the first set of processing modules;
another port for receiving the processed portion of the fluid from the second set of processing modules; and
a valve array comprising:
a first upper valve coupled between the inlet and a filter port of the pair of filter ports;
a first lower valve coupled between the filter port of the pair of filter ports and the exhaust;
a second upper valve coupled between the inlet and another filter port of the pair of filter ports;
a first lower valve coupled between the another filter port of the pair of filter ports and the exhaust; and
a central valve coupled between the pair of ports and the outlet; wherein
the first upper valve, the first lower valve, the second upper valve, the second lower valve and central valve are controllable to different states between an open state and a closed state under action of a controller to establish the device into a configuration of a series of configurations; and
the series of configurations comprises:
a first configuration wherein fluid from the first part of the fluidic system is coupled to the outlet after being processed by the one or more modules of the first set of processing modules;
a second configuration wherein fluid from the first part of the fluidic system is coupled to the outlet after being processed by the one or more modules of the second set of processing modules;
a third configuration wherein a portion of the fluid from the first part of the fluidic system is coupled to the outlet after being processed by the one or more modules of the first set of processing modules and another portion of the fluid from the first part of the fluidic system is coupled to the outlet after being processed by the one or more modules of the second set of processing modules;
a fourth configuration wherein a portion of the fluid from the first part of the fluidic system is coupled to the exhaust after being processed by the one or more modules of the first set of processing modules and employed to backwash one or more modules of the second set of processing modules; and
a fifth configuration wherein a portion of the fluid from the first part of the fluidic system is coupled to the exhaust after being processed by the one or more modules of the second set of processing modules and employed to backwash one or more modules of the first set of processing modules.

2. A device comprising:
a filter port of a pair of filter ports for receiving the fluid from an inlet and coupling it to one or more modules of a first set of processing modules;
another filter port of the pair of filter ports for receiving the fluid from the inlet and coupling it to one or more modules of a second set of processing modules;
a port for receiving the processed portion of the fluid from the first set of processing modules;
another port for receiving the processed portion of the fluid from the second set of processing modules; and
a valve array comprising:
a first upper valve coupled between the inlet and a filter port of the pair of filter ports;
a first lower valve coupled between the filter port of the pair of filter ports and the exhaust;
a second upper valve coupled between the inlet and another filter port of the pair of filter ports;
a first lower valve coupled between the another filter port of the pair of filter ports and the exhaust; and
a central valve coupled between the pair of ports and the outlet; wherein
the first upper valve, the first lower valve, the second upper valve, the second lower valve and central valve are controllable to different states between an open state and a closed state under action of a controller to establish the device into a configuration of a series of configurations; and
the series of configurations comprises:
a first configuration wherein fluid from the first part of the fluidic system is coupled to the outlet after being processed by the one or more modules of the first set of processing modules;
a second configuration wherein fluid from the first part of the fluidic system is coupled to the outlet after being processed by the one or more modules of the second set of processing modules;
a third configuration wherein a portion of the fluid from the first part of the fluidic system is coupled to the outlet after being processed by the one or more modules of the first set of processing modules and another portion of the fluid from the first part of the fluidic system is coupled to the outlet after being processed by the one or more modules of the second set of processing modules;
a fourth configuration wherein a portion of the fluid from the first part of the fluidic system is coupled to the exhaust after being processed by the one or more modules of the first set of processing modules and employed to one of backwash and rinse one or more modules of the second set of processing modules; and
a fifth configuration wherein a portion of the fluid from the first part of the fluidic system is coupled to the exhaust after being processed by the one or more modules of the second set of processing modules and employed to one of backwash and rinse one or more modules of the first set of processing modules.

3. A field deployable fluid processing system comprising:
a container;
a valve module; and
a number N fluid processing modules (FPMs) coupled to the valve module; wherein
an inlet comprising a pair of inlet ports for receiving a fluid from a first part of a fluidic system where the pair of inlet ports are disposed through one or more walls of the container;
an outlet comprising a pair of outlet ports for providing a processed portion of the fluid to a second part of the fluidic system where the pair of outlet ports are disposed through one or more walls of the container; and
an exhaust comprising a pair of exhaust ports for providing another processed portion of the fluid to another fluidic system where the pair of exhaust ports are disposed through one or more walls of the container.

4. The field deployable fluid processing system according to claim 3, wherein
either:
the container is a standard 40 foot shipping container and N is four;
or:
the container is a standard 53 foot shipping container and N is six.

5. The field deployable fluid processing system according to claim 3, further comprising
a filter port of a pair of filter ports for receiving the fluid from the inlet and coupling it to one or more modules of a first set of processing modules;
another filter port of the pair of filter ports for receiving the fluid from the inlet and coupling it to one or more modules of a second set of processing modules;
a port for receiving the processed portion of the fluid from the first set of processing modules;
another port for receiving the processed portion of the fluid from the second set of processing modules; and
a valve array comprising:
a first upper valve coupled between the inlet and a filter port of the pair of filter ports;
a first lower valve coupled between the filter port of the pair of filter ports and the exhaust;
a second upper valve coupled between the inlet and another filter port of the pair of filter ports;
a first lower valve coupled between the another filter port of the pair of filter ports and the exhaust; and
a central valve coupled between the pair of ports and the outlet; wherein
the first upper valve, the first lower valve, the second upper valve, the second lower valve and central valve are controllable between an open state and a closed state under action of a controller to establish the device into a configuration of a series of configurations.

6. The field deployable fluid processing system according to claim 5, wherein
the series of configurations comprises:
a first configuration wherein fluid from the first part of the fluidic system is coupled to the outlet after being processed by the one or more modules of the first set of processing modules;
a second configuration wherein fluid from the first part of the fluidic system is coupled to the outlet after being processed by the one or more modules of the second set of processing modules;
a third configuration wherein a portion of the fluid from the first part of the fluidic system is coupled to the outlet after being processed by the one or more modules of the first set of processing modules and another portion of the fluid from the first part of the fluidic system is coupled to the outlet after being processed by the one or more modules of the second set of processing modules;
a fourth configuration wherein a portion of the fluid from the first part of the fluidic system is coupled to the exhaust after being processed by the one or more modules of the first set of processing modules and employed to one of backwash and rinse one or more modules of the second set of processing modules; and
a fifth configuration wherein a portion of the fluid from the first part of the fluidic system is coupled to the exhaust after being processed by the one or more modules of the second set of processing modules and employed to one of backwash and rinse one or more modules of the first set of processing modules.

7. The field deployable fluid processing system according to claim 3, wherein
at least one of:
each FPM of the number N FPMs is coupled to the valve module via an on/off valve such that the FPM of the number N FPMs can be either isolated from the valve module when the field deployable fluid processing system is configured to backwash another FPM of the number N FPMs or isolated to allow the FPM of the number N FPMs to be installed, removed or replaced; and
an initial number N fluid processing modules (FPMs) coupled to the valve module can be increased by a number M FPMs where the addition of each FPM of the number M FPMs comprises adding an on/off valve to a preceding FPM such that the FPM of the number M FPMs can be added and then connected to the valve module and then subsequently isolated from the valve module when the field deployable fluid processing system is configured to at least one of backwash another FPM of the number N FPMs and allow the FPM of the number N FPMs to be removed or replaced; and
M is a positive integer.

8. The field deployable fluid processing system according to claim 3, wherein
the initial number N fluid processing modules (FPMs) coupled to the valve module can be increased by addition of an FPM which is coupled to a fluidic system coupled to one of the pair of filter ports and a subset of the number N FPMs by an on/off valve such that a processing capacity of the field deployable fluid processing system can be increased whilst the field deployable fluid processing system is in operation.

9. A field deployable fluid processing system comprising:
a first container comprising a number N fluid processing modules (FPMs) coupled to a valve module;
a second container comprising a number M fluid processing modules (FPMs) coupled to the valve module;
the valve module comprising:
an inlet comprising a pair of inlet ports for receiving a fluid from a first part of a fluidic system;
an outlet comprising a pair of outlet ports for providing a processed portion of the fluid to a second part of the fluidic system;
an exhaust comprising a pair of exhaust ports for providing another processed portion of the fluid to another fluidic system;
a filter port of a pair of filter ports for receiving the fluid from the inlet and coupling it to an inlet port of the first container;
another filter port of the pair of filter ports for receiving the fluid from the inlet and coupling it to an inlet port of the second container;
a port for receiving the processed portion of the fluid from an outlet port of the first container;
another port for receiving the processed portion of the fluid from an outlet port of the second container; and
a valve array comprising:
a first upper valve coupled between the inlet and a filter port of the pair of filter ports;
a first lower valve coupled between the filter port of the pair of filter ports and the exhaust;
a second upper valve coupled between the inlet and another filter port of the pair of filter ports;
a first lower valve coupled between the another filter port of the pair of filter ports and the exhaust; and
a central valve coupled between the pair of ports and the outlet; wherein
the first upper valve, the first lower valve, the second upper valve, the second lower valve and central valve are controllable between an open state and a closed state under action of a controller to establish the device into a configuration of a series of configurations; and
M and N are positive integers.

10. The field deployable fluid processing system according to claim 9, wherein
either:
the container is a standard 40 foot shipping container and N is four;
or:
the container is a standard 53 foot shipping container and N is six.

11. The field deployable fluid processing system according to claim 9, wherein
the series of configurations comprises:
a first configuration wherein fluid from the first part of the fluidic system is coupled to the outlet after being processed by the one or more modules of the first set of processing modules;
a second configuration wherein fluid from the first part of the fluidic system is coupled to the outlet after being processed by the one or more modules of the second set of processing modules;
a third configuration wherein a portion of the fluid from the first part of the fluidic system is coupled to the outlet after being processed by the one or more modules of the first set of processing modules and another portion of the fluid from the first part of the fluidic system is coupled to the outlet after being processed by the one or more modules of the second set of processing modules;
a fourth configuration wherein a portion of the fluid from the first part of the fluidic system is coupled to the exhaust after being processed by the one or more modules of the first set of processing modules and employed to one of backwash and rinse one or more modules of the second set of processing modules; and
a fifth configuration wherein a portion of the fluid from the first part of the fluidic system is coupled to the exhaust after being processed by the one or more modules of the second set of processing modules and employed to one of backwash and rinse one or more modules of the first set of processing modules.

12. The field deployable fluid processing system according to claim 9, wherein
at least one of:
each FPM of the number N FPMs is coupled to the valve module via an on/off valve such that the FPM of the number N FPMs can be either isolated from the valve module when the field deployable fluid processing system is configured to backwash another FPM of the number N FPMs or isolated to allow the FPM of the number N FPMs to be installed, removed or replaced; and
an initial number N fluid processing modules (FPMs) coupled to the valve module can be increased by a number M FPMs where the addition of each FPM of the number M FPMs comprises adding an on/off valve to a preceding FPM such that the FPM of the number M FPMs can be added and then connected to the valve module and then subsequently isolated from the valve module when the field deployable fluid processing system is configured to at least one of backwash another FPM of the number N FPMs and allow the FPM of the number N FPMs to be removed or replaced; and
M is a positive integer.

13. The field deployable fluid processing system according to claim 3, wherein
the FPMs coupled to the valve module within either the first container or the second container can be increased by addition of an FPM which is coupled to a fluidic system coupled to one of the pair of filter ports and a subset of the number N FPMs by an on/off valve such that a processing capacity of the field deployable fluid processing system can be increased whilst the field deployable fluid processing system is in operation.
